(19) United States
(12) Patent Application Publication
(10) Pub. No.: US 2026/0335797 A1
(43) Pub. Date: Oct. 29, 2026

(54) FILTERING MATERIAL PROCESSING METHOD, FILTERING MATERIAL, AND LITHOGRAPHY PROCESSING SOLUTION

(71) Applicant: Chang Chun Petrochemical Co., Ltd., Taipei City (TW)

(72) Inventor: Chang Ju TSAI, Taipei City (TW)

(21) Appl. No.: 19/654,820

(22) Filed: Apr. 22, 2026

Related U.S. Application Data
(60) Provisional application No. 63/792,527, filed on Apr. 22, 2025.

(30) Foreign Application Priority Data
Apr. 22, 2026 (TW) 115115748

(51) Int. Cl. B01D 37/02; B01D 39/16

(52) U.S. Cl. CPC B01D 37/025; B01D 39/16; B01D 2239/0464

(57) ABSTRACT

A method of processing a filtering material, comprising: step (I): exposing the filtering material to a processing liquid A, and step (II): exposing the filtering material to a processing liquid B, wherein, the processing liquid A is a tetramethylammonium hydroxide aqueous solution having a concentration of 0.4 wt % to 27.0 wt %, and the processing liquid B is a tetramethylammonium hydroxide aqueous solution having a concentration of 0.4 wt % to 5.5 wt %, and wherein, step (II) is performed after step (I), or step (I) is performed after step (II).

### CLAIM FOR PRIORITY

This application claims the benefit of U.S. Provisional Application No. 63/792,527, filed Apr. 22, 2025 and the benefit of Taiwan Patent Application No. 115115748, filed Apr. 22, 2026, the subject matters of which are incorporated herein in their entirety by reference.

### FIELD OF THE INVENTION

The present application relates to a filtering material processing method and the filtering material produced thereby. The method improves the filtration performance of the filtering material and is particularly suitable for filtration applications involving chemical solutions used in semiconductor manufacturing, such as photolithography solutions.

### BACKGROUND OF THE INVENTION

A wide variety of chemical solutions are used in semiconductor manufacturing. Depending on their applications, such chemical solutions include, but are not limited to, developer solutions used in photolithography processes (also referred to herein as “photolithography solutions”), thinners used for photoresist dilution and wafer cleaning, rinse solutions, etching solutions, cleaning solutions for removing particles and organic residues, and ultrapure water used in wet processes. These chemical solutions require filtration through high-performance filtering material to improve their quality and to prevent cone defects, haze formation, surface roughening, or yield loss in advanced processes caused by the presence of unexpected components.

With the development of artificial intelligence (AI) technologies, the requirements imposed on electronic-grade wafers have reached unprecedented levels. Conventional filtration technologies are gradually becoming incapable of satisfying the filtration requirements of chemical solutions for high-end applications.

### SUMMARY OF THE INVENTION

The present application is directed to a method of processing a filtering material, wherein the method improves the filtration performance of the filtering material (as demonstrated in the following examples by the low metal content achievable in chemical solutions), thereby satisfying the requirements of chemical solutions for high-end applications.

Therefore, a first aspect of the present application is to provide a method of processing a filtering material, comprising:
step (I): exposing the filtering material to a processing liquid A; and
step (II): exposing the filtering material to a processing liquid B,
wherein, the processing liquid A is an aqueous solution of tetramethylammonium hydroxide having a concentration of 0.4 wt % to 27.0 wt %, and the processing liquid B is an aqueous solution of tetramethylammonium hydroxide having a concentration of 0.4 wt % to 5.5 wt %, and wherein step (II) is performed after step (I), or step (I) is performed after step (II). In one embodiment, step (II) is performed after step (I).

In one embodiment, the exposure time in step (I) is 0.5 hours to 168.0 hours, and the exposure time in step (II) is 12.0 hours to 168.0 hours.

In one embodiment, the exposure manner in step (I) and step (II) is each independently selected from soaking, rinsing, flushing, or a combination thereof.

In one embodiment, processing liquid A has a tetramethylammonium hydroxide concentration different from that of processing liquid B.

In one embodiment, at least one of processing liquid A and processing liquid B comprises an additive selected from the group consisting of a surfactant, a defoamer, a pH stabilizer, a chelating agent, and combinations thereof.

In one embodiment, the method further comprises exposing the filtering material to pure water before performing step (I) and/or before performing step (II). The exposure time may range from 0.5 hours to 24.0 hours, and the exposure manner may be selected from soaking, rinsing, flushing, or a combination thereof.

In one embodiment, the filter medium of the filtering material is selected from the group consisting of polyethylene, polypropylene, polytetrafluoroethylene, polysulfone, polyamide, and combinations thereof.

In one embodiment, the filtering material processed by the method exhibits the following characteristics: after soaking the processed filtering material in a tetramethylammonium hydroxide aqueous solution under an ambient atmosphere (that is, in an air atmosphere and atmospheric pressure) at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium and lead in the tetramethylammonium hydroxide aqueous solution after soaking the filtering material, as determined using inductively coupled plasma mass spectrometry, is not greater than 300 ppt (parts per trillion (w/w)).

A second aspect of the present application is to provide a filtering material, which has the following characteristics: after soaking the filtering material in a tetramethylammonium hydroxide aqueous solution under an ambient atmosphere at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium, and lead in the tetramethylammonium hydroxide aqueous solution after soaking the filtering material, determined using inductively coupled plasma mass spectrometry, is not greater than 300 ppt.

A third aspect of the present application is to provide a filtering material, which is processed by the method according to the first aspect.

A fourth aspect of the present application is to provide a photolithography solution, which has the following characteristics: a total concentration of sodium, magnesium, aluminum, potassium, calcium, chromium, manganese, iron, cobalt, nickel, copper, zinc, silver, iridium, and lead in the photolithography solution, determined using inductively coupled plasma mass spectrometry, is not greater than 300 ppt. In one embodiment, the photolithography solution is a tetramethylammonium hydroxide aqueous solution.

A fifth aspect of the present application is to provide a photolithography solution, which is filtered through the filtering material according to the second aspect or the third aspect. In one embodiment, the photolithography solution is a tetramethylammonium hydroxide aqueous solution.

A sixth aspect of the present application is to provide a method of processing a filtering material, comprising:
step (I-2): exposing the filtering material to a processing liquid C;
step (I): exposing the filtering material to a processing liquid A; and
step (II): exposing the filtering material to a processing liquid B,
wherein, the processing liquid A is a tetramethylammonium hydroxide aqueous solution having a concentration of 0.4 wt % to 27.0 wt %. The processing liquid B is a tetramethylammonium hydroxide aqueous solution having a concentration of 0.4 wt % to 5.5 wt %. The processing liquid C is selected from the group consisting of hydrochloric acid, nitric acid, hydrofluoric acid, hydrogen peroxide, sulfuric acid, isopropyl alcohol, any combination of the foregoing components, and aqueous solutions comprising the foregoing components or any combination thereof. Steps (I-2), (I), and (II) may be performed in any order.

In one embodiment, step (II) is performed after step (I), and step (I-2) may be performed before step (I), after step (I) and before step (II), or after step (II).

In one embodiment, the exposure time in step (I-2) is 0.5 hours to 168.0 hours.

In one embodiment, processing liquid C is an aqueous solution of hydrochloric acid, nitric acid, hydrofluoric acid, hydrogen peroxide, sulfuric acid, isopropyl alcohol, or any combination thereof at a concentration of 0.5 wt % or more. More specifically, processing liquid C is an aqueous solution of isopropyl alcohol, hydrochloric acid, hydrogen peroxide, or any combination thereof at a concentration of 0.5 wt % or more.

In one embodiment, the filtering material is exposed to pure water before performing step (I-2), before performing step (I), and/or before performing step (II). The exposure time may be from 0.5 hours to 24.0 hours, and the exposure manner may be selected from soaking, rinsing, flushing, or a combination thereof.

A seventh aspect of the present application is to provide a filtering material, which is processed by the method according to the sixth aspect.

An eighth aspect of the present application is to provide a photolithography solution, which is filtered through the filtering material according to the seventh aspect. In one embodiment, the photolithography solution is a tetramethylammonium hydroxide aqueous solution.

In order to make the aforementioned aspects, technical features, and advantages of the present application more apparent, the present application will be described in detail with reference to some embodiments hereinafter.

### DESCRIPTION OF THE PREFERRED EMBODIMENTS

Hereinafter, some embodiments of the present application will be described in detail. However, the present application can be implemented in various embodiments and should not be limited to the described specific embodiments.

Unless otherwise specified, the terms “a,” “the,” and similar expressions used in this specification and the claims of the present application encompass both singular and plural forms.

Unless otherwise specified, the numerical ranges used in this specification and the claims (for example, 5 to 100) include all rational numbers within the range as well as any ranges composed of rational numbers within the range. Therefore, the numerical ranges used in this specification include all possible combinations of values between the minimum and maximum values listed.

Unless otherwise specified, the terms “first,” “second,” “step (I),” “step (II),” and similar expressions used in this specification and the claims are used to distinguish the described elements, components, or steps, and do not have special meanings themselves, nor do they intend to indicate a sequential order.

The present application provides advantages over the prior art in that it provides a filtering material processing method. A filtering material produced by the method of the present application exhibits improved performance (as demonstrated in the following examples by the low metal content achievable in chemical solutions). Therefore, the filtering material is particularly suitable for chemical solutions used in semiconductor manufacturing.

### 1. Method of Processing Filtering Material According to the First Aspect

The filtering material processing method according to the first aspect comprises the following steps: (I) exposing the filtering material to a processing liquid A; and (II) exposing the filtering material to a processing liquid B. Step (II) is performed after step (I), or step (I) is performed after step (II). In one embodiment, step (II) is performed after step (I).

The term “expose” refers to bringing at least the filter medium of the filtering material into contact with the corresponding processing liquid. Preferably, the filter medium of the filtering material, as well as portions of the filtering material that are expected to come into contact with the target to be filtered (such as a chemical solution), are both brought into contact with the corresponding processing liquid. The manner of exposure is not particularly limited, and may include, for example, soaking, rinsing, flushing, or a combination thereof; however, the present aspect is not limited thereto. In addition, the manner of exposure in step (I) and step (II) may be the same or different.

### 1.1. Step (I)

Processing liquid A is a tetramethylammonium hydroxide aqueous solution having a concentration of 0.4 wt % to 27.0 wt %, more specifically 0.5 wt % to 27.0 wt %, and even more specifically 1.0 wt % to 25.0 wt %. For example, the concentration of tetramethylammonium hydroxide in processing liquid A may be 0.4 wt %, 0.5 wt %, 1.0 wt %, 1.5 wt %, 2.0 wt %, 2.1 wt %, 2.2 wt %, 2.30 wt %, 2.31 wt %, 2.32 wt %, 2.33 wt %, 2.34 wt %, 2.35 wt %, 2.36 wt %, 2.37 wt %, 2.38 wt %, 2.39 wt %, 2.40 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, 15.0 wt %, 15.5 wt %, 16.0 wt %, 16.5 wt %, 17.0 wt %, 17.5 wt %, 18.0 wt %, 18.5 wt %, 19.0 wt %, 19.5 wt %, 20.0 wt %, 20.5 wt %, 21.0 wt %, 21.5 wt %, 22.0 wt %, 22.5 wt %, 23.0 wt %, 23.5 wt %, 24.0 wt %, 24.1 wt %, 24.2 wt %, 24.3 wt %, 24.4 wt %, 24.5 wt %, 24.6 wt %, 24.7 wt %, 24.8 wt %, 24.90 wt %, 24.91 wt %, 24.92 wt %, 24.93 wt %, 24.94 wt %, 24.95 wt %, 24.96 wt %, 24.97 wt %, 24.98 wt %, 24.99 wt %, 25.0 wt %, 25.5 wt %, 26.0 wt %, 26.5 wt %, or 27.0 wt %, or within a range between any two of the aforementioned values.

In step (I), the exposure time to processing liquid A may be selected as needed. In one embodiment, in view of a balance between improved filtration performance and time cost, the exposure time to processing liquid A is 0.5 hours to 168.0 hours, more specifically 0.5 hours to 156.0 hours, still more specifically 0.5 hours to 150.0 hours, still more specifically 0.5 hours to 146.0 hours, and even more specifically 0.5 hours to 144.0 hours. For example, the exposure time to processing liquid A in step (I) may be 0.5 hours, 1.0 hour, 1.5 hours, 2.0 hours, 2.5 hours, 3.0 hours, 3.5 hours, 4.0 hours, 4.5 hours, 5.0 hours, 5.5 hours, 6.0 hours, 6.5 hours, 7.0 hours, 7.5 hours, 8.0 hours, 8.5 hours, 9.0 hours, 9.5 hours, 10.0 hours, 10.5 hours, 11.0 hours, 11.5 hours, 12.0 hours, 12.5 hours, 13.0 hours, 13.5 hours, 14.0 hours, 14.5 hours, 15.0 hours, 15.5 hours, 16.0 hours, 16.5 hours, 17.0 hours, 17.5 hours, 18.0 hours, 18.5 hours, 19.0 hours, 19.5 hours, 20.0 hours, 20.5 hours, 21.0 hours, 21.5 hours, 22.0 hours, 22.5 hours, 23.0 hours, 23.5 hours, 24.0 hours, 25.0 hours, 26.0 hours, 27.0 hours, 28.0 hours, 29.0 hours, 30.0 hours, 31.0 hours, 32.0 hours, 33.0 hours, 34.0 hours, 35.0 hours, 36.0 hours, 37.0 hours, 38.0 hours, 39.0 hours, 40.0 hours, 41.0 hours, 42.0 hours, 43.0 hours, 44.0 hours, 45.0 hours, 46.0 hours, 47.0 hours, 48.0 hours, 49.0 hours, 50.0 hours, 51.0 hours, 52.0 hours, 53.0 hours, 54.0 hours, 55.0 hours, 56.0 hours, 57.0 hours, 58.0 hours, 59.0 hours, 60.0 hours, 61.0 hours, 62.0 hours, 63.0 hours, 64.0 hours, 65.0 hours, 66.0 hours, 67.0 hours, 68.0 hours, 69.0 hours, 70.0 hours, 71.0 hours, 72.0 hours, 73.0 hours, 74.0 hours, 75.0 hours, 76.0 hours, 77.0 hours, 78.0 hours, 79.0 hours, 80.0 hours, 81.0 hours, 82.0 hours, 83.0 hours, 84.0 hours, 85.0 hours, 86.0 hours, 87.0 hours, 88.0 hours, 89.0 hours, 90.0 hours, 91.0 hours, 92.0 hours, 93.0 hours, 94.0 hours, 95.0 hours, 96.0 hours, 97.0 hours, 98.0 hours, 99.0 hours, 100.0 hours, 101.0 hours, 102.0 hours, 103.0 hours, 104.0 hours, 105.0 hours, 106.0 hours, 107.0 hours, 108.0 hours, 109.0 hours, 110.0 hours, 111.0 hours, 112.0 hours, 113.0 hours, 114.0 hours, 115.0 hours, 116.0 hours, 117.0 hours, 118.0 hours, 119.0 hours, 120.0 hours, 121.0 hours, 122.0 hours, 123.0 hours, 124.0 hours, 125.0 hours, 126.0 hours, 127.0 hours, 128.0 hours, 129.0 hours, 130.0 hours, 131.0 hours, 132.0 hours, 133.0 hours, 134.0 hours, 135.0 hours, 136.0 hours, 137.0 hours, 138.0 hours, 139.0 hours, 140.0 hours, 141.0 hours, 142.0 hours, 143.0 hours, 144.0 hours, 144.5 hours, 145.0 hours, 145.5 hours, 146.0 hours, 146.5 hours, 147.0 hours, 147.5 hours, 148.0 hours, 148.5 hours, 149.0 hours, 149.5 hours, 150.0 hours, 150.5 hours, 151.0 hours, 151.5 hours, 152.0 hours, 152.5 hours, 153.0 hours, 153.5 hours, 154.0 hours, 154.5 hours, 155.0 hours, 155.5 hours, 156.0 hours, 156.5 hours, 157.0 hours, 157.5 hours, 158.0 hours, 158.5 hours, 159.0 hours, 159.5 hours, 160.0 hours, 160.5 hours, 161.0 hours, 161.5 hours, 162.0 hours, 162.5 hours, 163.0 hours, 163.5 hours, 164.0 hours, 164.5 hours, 165.0 hours, 165.5 hours, 166.0 hours, 166.5 hours, 167.0 hours, 167.5 hours, or 168.0 hours, or within a range between any two of the aforementioned values. The “exposure time” excludes the time elapsed during the process of draining processing liquid A from the filtering material.

In step (I), the exposure to processing liquid A may be completed in a single stage or may be carried out in multiple stages. In the case of a multi-stage process, the exposure time refers to the total exposure time obtained by summing the exposure time of each stage, and excludes the time elapsed during the process of draining processing liquid A from the filtering material in each stage. For example, in the appended examples, some examples adopt a two-stage exposure process, including two-stage exposures with exposure times of 72 hours and 96 hours, and two-stage exposures with exposure times of 72 hours and 72 hours; however, the present application is not limited thereto.

Processing liquid A may optionally contain other optional components as needed. The optional component may, for example, be an additive commonly used in chemical solutions. Examples of the additive include, but are not limited to, a surfactant, a defoamer, a pH stabilizer, and a chelating agent. Each of the additives may be used individually or in any combination. The optional component may also be added to processing liquid B.

The surfactants comprise anionic surfactants, non-ionic surfactants, and cationic surfactants. Examples of anionic surfactants include, but are not limited to, alkylsulfonic acid esters, alkylsulfonic acid, alkylbenzenesulfonic acid, alkylnaphthalenesulfonic acid, alkyldiphenylethersulfonic acid, polyoxyethylene alkyl ether carboxylic acid, polyoxyethylene alkyl ether acetic acid, polyoxyethylene alkyl ether propionic acid, polyoxyethylene alkyl ether sulfuric acid, polyoxyethylene aryl ether acetic acid, polyoxyethylene aryl ether propionic acid, polyoxyethylene aryl ether sulfuric acid, and salts thereof. Examples of non-ionic surfactants include, but are not limited to, a polyalkylene oxide alkylphenyl ether surfactant, a polyalkylene oxide alkyl ether surfactant, a block polymer surfactant including polyethylene oxide and polypropylene oxide, a polyoxyalkylene distyrenated phenyl ether surfactant, a polyalkylene tribenzylphenyl ether surfactant, and an acetylene polyalkylene oxide surfactant. Specific representative compounds include 2,5,8,11-tetramethyl-6-dodecyne-5,8-diol, 5,8-dimethyl-6-dodecyne-5,8-diol, 2,4,7,9-tetramethyl-5-decyne-4,7-diol, 4,7-dimethyl-5-decyne-4,7-diol, 8-hexadecyne-7,10-diol, 7-tetradecyne-6,9-diol, 2,3,6,7-tetramethyl-4-octyne-3,6-diol, 3,6-diethyl-4-octyne-3,6-diol, 3,6-dimethyl-4-octyne-3,6-diol, and 2,5-dimethyl-3-hexyne-2,5-diol. Examples of cationic surfactants include but are not limited to quaternary ammonium salt surfactants, such as tetramethylammonium chloride, tetrabutylammonium chloride, dodecyldimethylbenzylammonium chloride, alkyltrimethylammonium chloride, octyltrimethylammonium chloride, decyltrimethylammonium chloride, dodecyltrimethylammonium chloride, tetradecyltrimethylammonium chloride, cetyltrimethylammonium chloride, and stearyltrimethylammonium chloride; and alkylpyridinium surfactants, such as butylpyridinium chloride, dodecylpyridinium chloride, and cetylpyridinium chloride. The aforementioned surfactants may be used individually or in any combination.

Examples of defoamers include but are not limited to: silane-based defoamers, such as polydimethylsiloxane and polyether-modified siloxane; organic alcohol-based defoamers, such as polyethylene glycol and polypropylene glycol; and hydrocarbon-based defoamers, such as mineral oil and white oil.

Examples of pH stabilizers include, but are not limited to, phosphates, such as monosodium phosphate and disodium phosphate, and organic amines, such as triethanolamine and ethanolamine. Examples of chelating agents include, but are not limited to, ethylenediaminetetraacetic acid (EDTA), nitrilotriacetic acid (NTA), citric acid, and phosphates such as tetrasodium pyrophosphate.

In one embodiment, processing liquid A and processing liquid B are substantially free of additives (i.e., the concentration of additive is 1 ppm or less), and more specifically are substantially free of surfactants (i.e., the concentration of surfactant is 1 ppm or less). In one embodiment, only processing liquid A contains a surfactant, or only processing liquid B contains a surfactant; alternatively, both processing liquid A and processing liquid B contain a surfactant. The surfactant may be an anionic surfactant, a non-ionic surfactant, or a cationic surfactant. The concentration of the surfactant may be 1 ppm to 100000 ppm, more specifically 50 ppm to 10000 ppm, and even more specifically 100 ppm to 5000 ppm. For example, the concentration of the surfactant may be 100 ppm, 200 ppm, 300 ppm, 400 ppm, 500 ppm, 600 ppm, 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, 3500 ppm, 3600 ppm, 3700 ppm, 3800 ppm, 3900 ppm, 4000 ppm, 4100 ppm, 4200 ppm, 4300 ppm, 4400 ppm, 4500 ppm, 4600 ppm, 4700 ppm, 4800 ppm, 4900 ppm, or 5000 ppm, or within a range between any two of the aforementioned values.

### 1.2. Step (II)

Processing liquid B is an aqueous solution of tetramethylammonium hydroxide having a concentration of 0.40 wt % to 5.50 wt %, more specifically 0.40 wt % to 5.00 wt %, still more specifically 0.50 wt % to 5.00 wt %, still more specifically 1.00 wt % to 5.00 wt %, still more specifically 1.25 wt % to 4.75 wt %, still more specifically 1.50 wt % to 4.50 wt %, still more specifically 1.75 wt % to 4.25 wt %, still more specifically 2.00 wt % to 4.00 wt %. For example, the concentration of tetramethylammonium hydroxide in processing liquid B may be 0.40 wt %, 0.50 wt %, 1.00 wt %, 1.05 wt %, 1.10 wt %, 1.15 wt %, 1.20 wt %, 1.25 wt %, 1.30 wt %, 1.35 wt %, 1.40 wt %, 1.45 wt %, 1.50 wt %, 1.55 wt %, 1.60 wt %, 1.65 wt %, 1.70 wt %, 1.75 wt %, 1.80 wt %, 1.85 wt %, 1.90 wt %, 1.95 wt %, 2.00 wt %, 2.01 wt %, 2.02 wt %, 2.03 wt %, 2.04 wt %, 2.05 wt %, 2.06 wt %, 2.07 wt %, 2.08 wt %, 2.09 wt %, 2.10 wt %, 2.11 wt %, 2.12 wt %, 2.13 wt %, 2.14 wt %, 2.15 wt %, 2.16 wt %, 2.17 wt %, 2.18 wt %, 2.19 wt %, 2.20 wt %, 2.21 wt %, 2.22 wt %, 2.23 wt %, 2.24 wt %, 2.25 wt %, 2.26 wt %, 2.27 wt %, 2.28 wt %, 2.29 wt %, 2.30 wt %, 2.31 wt %, 2.32 wt %, 2.33 wt %, 2.34 wt %, 2.35 wt %, 2.36 wt %, 2.37 wt %, 2.38 wt %, 2.39 wt %, 2.40 wt %, 2.41 wt %, 2.42 wt %, 2.43 wt %, 2.44 wt %, 2.45 wt %, 2.46 wt %, 2.47 wt %, 2.48 wt %, 2.49 wt %, 2.50 wt %, 2.51 wt %, 2.52 wt %, 2.53 wt %, 2.54 wt %, 2.55 wt %, 2.56 wt %, 2.57 wt %, 2.58 wt %, 2.59 wt %, 2.60 wt %, 2.61 wt %, 2.62 wt %, 2.63 wt %, 2.64 wt %, 2.65 wt %, 2.66 wt %, 2.67 wt %, 2.68 wt %, 2.69 wt %, 2.70 wt %, 2.71 wt %, 2.72 wt %, 2.73 wt %, 2.74 wt %, 2.75 wt %, 2.76 wt %, 2.77 wt %, 2.78 wt %, 2.79 wt %, 2.80 wt %, 2.81 wt %, 2.82 wt %, 2.83 wt %, 2.84 wt %, 2.85 wt %, 2.86 wt %, 2.87 wt %, 2.88 wt %, 2.89 wt %, 2.90 wt %, 2.91 wt %, 2.92 wt %, 2.93 wt %, 2.94 wt %, 2.95 wt %, 2.96 wt %, 2.97 wt %, 2.98 wt %, 2.99 wt %, 3.00 wt %, 3.05 wt %, 3.10 wt %, 3.15 wt %, 3.20 wt %, 3.25 wt %, 3.30 wt %, 3.35 wt %, 3.40 wt %, 3.45 wt %, 3.50 wt %, 3.55 wt %, 3.60 wt %, 3.65 wt %, 3.70 wt %, 3.75 wt %, 3.80 wt %, 3.85 wt %, 3.90 wt %, 3.95 wt %, 4.00 wt %, 4.05 wt %, 4.10 wt %, 4.15 wt %, 4.20 wt %, 4.25 wt %, 4.30 wt %, 4.35 wt %, 4.40 wt %, 4.45 wt %, 4.50 wt %, 4.55 wt %, 4.60 wt %, 4.65 wt %, 4.70 wt %, 4.75 wt %, 4.80 wt %, 4.85 wt %, 4.90 wt %, 4.95 wt %, 5.00 wt %, 5.05 wt %, 5.10 wt %, 5.15 wt %, 5.20 wt %, 5.25 wt %, 5.30 wt %, 5.35 wt %, 5.40 wt %, 5.45 wt %, or 5.50 wt %, or within a range between by any two of the aforementioned values. In addition, the concentration of tetramethylammonium hydroxide in processing liquid B may be the same as or different from that in processing liquid A. In one embodiment, the concentration of tetramethylammonium hydroxide in processing liquid A is different from the concentration of tetramethylammonium hydroxide in processing liquid B.

In step (II), the exposure time to processing liquid B may be selected as needed. In one embodiment, in view of a balance between improved filtration performance and time cost, the exposure time to processing liquid B may be 12.0 hours to 168.0 hours, more specifically 14.0 hours to 156.0 hours, still more specifically 16.0 hours to 144.0 hours, still more specifically 18.0 hours to 132.0 hours, and still more specifically 20.0 hours to 120.0 hours. For example, the exposure time to processing liquid B in step (II) may be 12.0 hours, 12.5 hours, 13.0 hours, 13.5 hours, 14.0 hours, 14.5 hours, 15.0 hours, 15.5 hours, 16.0 hours, 16.5 hours, 17.0 hours, 17.5 hours, 18.0 hours, 18.5 hours, 19.0 hours, 19.5 hours, 20.0 hours, 20.5 hours, 21.0 hours, 21.5 hours, 22.0 hours, 22.5 hours, 23.0 hours, 23.5 hours, 24.0 hours, 25.0 hours, 26.0 hours, 27.0 hours, 28.0 hours, 29.0 hours, 30.0 hours, 31.0 hours, 32.0 hours, 33.0 hours, 34.0 hours, 35.0 hours, 36.0 hours, 37.0 hours, 38.0 hours, 39.0 hours, 40.0 hours, 41.0 hours, 42.0 hours, 43.0 hours, 44.0 hours, 45.0 hours, 46.0 hours, 47.0 hours, 48.0 hours, 49.0 hours, 50.0 hours, 51.0 hours, 52.0 hours, 53.0 hours, 54.0 hours, 55.0 hours, 56.0 hours, 57.0 hours, 58.0 hours, 59.0 hours, 60.0 hours, 61.0 hours, 62.0 hours, 63.0 hours, 64.0 hours, 65.0 hours, 66.0 hours, 67.0 hours, 68.0 hours, 69.0 hours, 70.0 hours, 71.0 hours, 72.0 hours, 73.0 hours, 74.0 hours, 75.0 hours, 76.0 hours, 77.0 hours, 78.0 hours, 79.0 hours, 80.0 hours, 81.0 hours, 82.0 hours, 83.0 hours, 84.0 hours, 85.0 hours, 86.0 hours, 87.0 hours, 88.0 hours, 89.0 hours, 90.0 hours, 91.0 hours, 92.0 hours, 93.0 hours, 94.0 hours, 95.0 hours, 96.0 hours, 97.0 hours, 98.0 hours, 99.0 hours, 100.0 hours, 101.0 hours, 102.0 hours, 103.0 hours, 104.0 hours, 105.0 hours, 106.0 hours, 107.0 hours, 108.0 hours, 109.0 hours, 110.0 hours, 111.0 hours, 112.0 hours, 113.0 hours, 114.0 hours, 115.0 hours, 116.0 hours, 117.0 hours, 118.0 hours, 119.0 hours, 120.0 hours, 121.0 hours, 122.0 hours, 123.0 hours, 124.0 hours, 125.0 hours, 126.0 hours, 127.0 hours, 128.0 hours, 129.0 hours, 130.0 hours, 131.0 hours, 132.0 hours, 133.0 hours, 134.0 hours, 135.0 hours, 136.0 hours, 137.0 hours, 138.0 hours, 139.0 hours, 140.0 hours, 141.0 hours, 142.0 hours, 143.0 hours, 144.0 hours, 144.5 hours, 145.0 hours, 145.5 hours, 146.0 hours, 146.5 hours, 147.0 hours, 147.5 hours, 148.0 hours, 148.5 hours, 149.0 hours, 149.5 hours, 150.0 hours, 150.5 hours, 151.0 hours, 151.5 hours, 152.0 hours, 152.5 hours, 153.0 hours, 153.5 hours, 154.0 hours, 154.5 hours, 155.0 hours, 155.5 hours, 156.0 hours, 156.5 hours, 157.0 hours, 157.5 hours, 158.0 hours, 158.5 hours, 159.0 hours, 159.5 hours, 160.0 hours, 160.5 hours, 161.0 hours, 161.5 hours, 162.0 hours, 162.5 hours, 163.0 hours, 163.5 hours, 164.0 hours, 164.5 hours, 165.0 hours, 165.5 hours, 166.0 hours, 166.5 hours, 167.0 hours, 167.5 hours, or 168.0 hours, or within a range between any two of the aforementioned values. The “exposure time” excludes the time elapsed during the process of draining processing liquid B from the filtering material.

In step (II), the exposure of processing liquid B may be completed in a single stage or may be carried out in multiple stages. In the case of a multi-stage process, the exposure time refers to the total exposure time obtained by summing the exposure time of each stage, and excludes the time elapsed during the process of draining processing liquid B from the filtering material in each stage. For example, in the appended examples, some examples adopt a two-stage exposure process, including two-stage exposures with exposure times of 48 hours and 24 hours, two-stage exposures with exposure times of 48 hours and 48 hours, three-stage exposures with exposure times of 48 hours, 48 hours, and 48 hours, and four-stage exposures with exposure times of 48 hours, 48 hours, 48 hours, and 24 hours, but the present application is not limited thereto.

As described above, processing liquid B may also contain other optional components as needed, and the relevant descriptions of the optional components are disclosed above and are not repeated herein for brevity.

### 1.3. Filtering Material

The type of filtering material applicable to the processing method of the present application is not particularly limited and may be selected depending on the actual filtration task. In one embodiment, the filter medium of the filtering material is selected from polyethylene, polypropylene, polytetrafluoroethylene, polysulfone, and polyamide. Preferably, the filter medium is selected from polyethylene and polytetrafluoroethylene. More preferably, the filter medium is selected from high molecular weight polyethylene (HMWPE), ultra-high molecular weight polyethylene (UHMWPE), and polytetrafluoroethylene. The filter medium may be used individually or in any combination.

### 1.4. Optional Method Features

The filtering material processing method of the present application enhances the filtration performance of the filtering material and effectively reduces the metal content in the filtered chemical solution, thereby meeting the requirement for low metal content in chemical solutions used in semiconductor manufacturing for advanced applications. In addition, by adjusting the concentration and/or exposure time of the processing liquid in step (I) and step (II), or by repeatedly performing step (I) and step (II), the filtration performance improvement achieved by the filtering material processing method can be further enhanced. Therefore, in one embodiment, the filtering material processing method according to the present aspect further comprises performing step (I) and step (II) such that the filtering material satisfies the following condition: after soaking the processed filtering material in a tetramethylammonium hydroxide aqueous solution under an ambient atmosphere at 10 °C to 40 °C for 24 hours, and removing the filtering material therefrom, a total concentration of atoms, a total concentration of ions, or a total concentration of atoms and ions of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material, determined using inductively coupled plasma mass spectrometry, is not greater than 300 ppt, preferably not greater than 200 ppt. For example, the total concentration of these elements may be not greater than 290 ppt, not greater than 280 ppt, not greater than 270 ppt, not greater than 260 ppt, not greater than 250 ppt, not greater than 240 ppt, not greater than 230 ppt, not greater than 220 ppt, not greater than 210 ppt, not greater than 200 ppt, not greater than 190 ppt, not greater than 180 ppt, not greater than 170 ppt, not greater than 160 ppt, not greater than 150 ppt, not greater than 140 ppt, not greater than 130 ppt, not greater than 120 ppt, not greater than 110 ppt, not greater than 100 ppt, not greater than 90 ppt, not greater than 80 ppt, not greater than 70 ppt, not greater than 60 ppt, not greater than 50 ppt, not greater than 40 ppt, not greater than 30 ppt, not greater than 20 ppt, or not greater than 10 ppt.

The concentration of tetramethylammonium hydroxide in the tetramethylammonium hydroxide aqueous solution may be selected as needed, and the concentration ranges and exemplified values for processing liquid A and processing liquid B described in the first aspect are incorporated herein by reference, apply equally to the present aspect, and are not repeated herein for brevity. In one embodiment, the concentration of tetramethylammonium hydroxide in the tetramethylammonium hydroxide aqueous solution is 2.00 wt % to 3.00 wt %, preferably 2.37 wt % to 2.38 wt %. In the appended examples, the concentration of tetramethylammonium hydroxide in the tetramethylammonium hydroxide aqueous solution is 2.38 wt %.

In addition, the filtering material processing method according to the present aspect may optionally include a step of washing the filtering material with water between the respective steps. Therefore, in one embodiment, the filtering material processing method according to the present aspect further comprises one or more steps of exposing the filtering material to water, wherein the step of exposing the filtering material to water may be performed at one or more timings before performing step (I), after performing step (I), before performing step (II), and after performing step (II). Examples of the water include, but are not limited to, tap water, reverse osmosis water, deionized water, pure water, and ultrapure water (i.e., having a resistivity value greater than 18.2 MΩ·cm at 25 °C), preferably pure water or ultrapure water, more preferably ultrapure water. The manner of exposure is not particularly limited, and examples thereof include, but are not limited to, soaking, rinsing, flushing, or a combination thereof. The exposure time may be selected as needed and is generally from 0.5 hours to 24.0 hours; however, the present application is not limited thereto.

### 2. Filtering Material According to the Second Aspect

The filtering material processing method according to the first aspect improves the filtration performance of filtering material and reduces the metal content in the filtered chemical solution. Therefore, the second aspect of the present application is to provide a filtering material which has the following characteristics: after soaking the filtering material in a tetramethylammonium hydroxide aqueous solution under an ambient atmosphere at 10 °C to 40 °C for 24 hours, and removing the filtering material therefrom, the total concentration of atoms, total concentration of ions, or total concentration of atoms and ions of sodium, magnesium, aluminum, potassium, calcium, chromium, manganese, iron, cobalt, nickel, copper, zinc, silver, iridium, and lead in the tetramethylammonium hydroxide aqueous solution after soaking the filtering material, as determined using inductively coupled plasma mass spectrometry, is not greater than 300 ppt, preferably not greater than 200 ppt. The exemplary values of the total concentration of these elements described in section 1.4 of the first aspect are incorporated herein by reference, apply equally to the present aspect, and are not repeated herein for brevity.

The concentration of tetramethylammonium hydroxide in the tetramethylammonium hydroxide aqueous solution may be selected as needed, and the concentration ranges and exemplary values described above for processing liquid A and processing liquid B are incorporated herein by reference, apply equally to the present aspect, and are not repeated herein for brevity.

### 3. Filtering Material According to the Third Aspect

The filtering material processing method according to the first aspect improves the filtration performance of the filtering material. Therefore, a third aspect of the present application is to provide a filtering material processed by the filtering material processing method according to the first aspect.

The filtering material produced by the filtering material processing method of the present application has enhanced filtration performance. For example, the chemical solution filtered as shown in the appended examples achieves low metal content. Therefore, the filtering material is particularly suitable for chemical solutions used in semiconductor manufacturing that require extremely low metal content. One example of application is a filtration task during a filling process of a chemical solution for semiconductor manufacturing. Specifically, a filling method of a chemical solution for semiconductor manufacturing comprises filtering the chemical solution with a filtering unit and filling the filtered chemical solution into a storage container, wherein the filtering unit comprises a filtering material processed by the filtering material processing method of the present application. Another example of application is a filtration task during the preparation process of chemical solutions for semiconductor manufacturing. Specifically, a method for manufacturing a chemical solution for semiconductor manufacturing comprises mixing raw materials to prepare the chemical solution, and filtering the chemical solution with a filtering unit, wherein the filtering unit comprises a filtering material processed by the filtering material processing method of the present application. Yet another example of application is a filtration task in the pretreatment of a chemical solution for semiconductor manufacturing in a use environment. Specifically, a processing method of a chemical solution for semiconductor manufacturing comprises filtering the chemical solution for semiconductor manufacturing with a filtering unit, wherein the filtering unit comprises a filtering material processed by the filtering material processing method of the present application, and treating an object to be processed with the filtered chemical solution in order to perform a desired process, such as etching of a silicon-based substrate surface, cleaning after etching, development, cleaning after chemical vapor deposition (CVD), cleaning after physical vapor deposition (PVD), cleaning after chemical mechanical planarization (CMP), and the like. Examples of chemical solutions used in the above applications include, but are not limited to, photolithography solutions, rinsing solutions, etching solutions, and cleaning solutions. Examples of the photolithography solutions include tetramethylammonium hydroxide aqueous solution, methyltriethanolammonium hydroxide aqueous solution, trimethylbenzylammonium hydroxide aqueous solution, potassium hydroxide aqueous solution, sodium hydroxide aqueous solution, triethanolamine aqueous solution, and aqueous alkaline solutions having a pH of 10 to 14.

### 4. Chemical Solution According to the Fourth Aspect

The filtering material processing method according to the first aspect improves the filtration performance of the filtering material and reduces the metal content in the filtered chemical solution. Therefore, a fourth aspect of the present application provides a chemical solution characterized by having a total concentration of atoms, ions, or atoms and ions of sodium, magnesium, aluminum, potassium, calcium, chromium, manganese, iron, cobalt, nickel, copper, zinc, silver, iridium, and lead of not greater than 300 ppt, preferably not greater than 200 ppt, wherein the total concentration is determined using inductively coupled plasma mass spectrometry. The exemplary values of the total concentration of these elements mentioned above are incorporated herein by reference, apply equally to the present aspect, and are not repeated herein for brevity.

In one embodiment, the chemical solution is a photolithography solution, more specifically a tetramethylammonium hydroxide aqueous solution, and even more specifically a tetramethylammonium hydroxide aqueous solution having a concentration of 0.4 wt % to 0.5 wt %, 2.37 wt % to 5.5 wt %, 20 wt %, 24.8 wt %, 24.99 wt %, or 25 wt %.

### 5. Chemical Solution According to the Fifth Aspect

The filtering material treated by the filtering material processing method of the first aspect has enhanced filtration performance and is effective in reducing the metal content in the filtered chemical solution. Therefore, a fifth aspect of the present application is to provide a chemical solution which is filtered by the filtering material according to the second aspect or the third aspect.

In one embodiment, the chemical solution is a photolithography solution, more specifically a tetramethylammonium hydroxide aqueous solution, and even more specifically a tetramethylammonium hydroxide aqueous solution having a concentration of 0.4 wt % to 0.5 wt %, 2.37 wt % to 5.5 wt %, 20 wt %, 24.8 wt %, 24.99 wt %, or 25 wt %.

### 6. Method of Processing a Filtering Material According to the Sixth Aspect

The filtering material processing method of the sixth aspect comprises:
(I-2) exposing the filtering material to a processing liquid C
(I) exposing the filtering material to a processing liquid A; and
(II) exposing the filtering material to a processing liquid B.

The step (I-2), step (I), and step (II) may be performed in any order. In one embodiment, step (II) is performed after step (I), and step (I-2) may be performed before step (I), after step (I) and before step (II), or after step (II).

The term “expose” refers to bringing at least the filter medium of the filtering material into contact with the corresponding processing liquid. Preferably, the filter medium of the filtering material, as well as portions of the filtering material that are expected to come into contact with the target to be filtered (such as a chemical solution), are both brought into contact with the corresponding processing liquid. The manner of exposure is not particularly limited, and may include, for example, soaking, rinsing, flushing or a combination thereof; however, the present aspect is not limited thereto. In addition, the manner of exposure in step (I-2), step (I), and step (II) may be the same or different.

### 6.1. Step (I-2)

Processing liquid C may be any one of hydrochloric acid, nitric acid, hydrofluoric acid, hydrogen peroxide, sulfuric acid, and isopropyl alcohol, or a mixture of two or more of these components. In one embodiment, processing liquid C is an aqueous solution of hydrochloric acid, nitric acid, hydrofluoric acid, hydrogen peroxide, sulfuric acid, isopropyl alcohol, or any combination thereof, having a concentration of 0.5 wt % or more. In an embodiment where processing liquid C comprises two or more of the aforementioned components, the concentration value means that each of the components is present at a concentration of 0.5 wt % or more.

More specifically, the processing liquid C may be an aqueous solution of hydrochloric acid, hydrogen peroxide, nitric acid, hydrofluoric acid, or any combination thereof, having a concentration of 0.5 wt % to 50.0 wt %. For example, the processing liquid C may be an aqueous solution of hydrochloric acid, hydrogen peroxide, nitric acid, hydrofluoric acid, or any combination thereof, having a concentration of 0.5 wt %, 1.0 wt %, 2.0 wt %, 3.0 wt %, 4.0 wt %, 5.0 wt %, 6.0 wt %, 7.0 wt %, 8.0 wt %, 9.0 wt %, 10.0 wt %, 11.0 wt %, 12.0 wt %, 13.0 wt %, 14.0 wt %, 15.0 wt %, 16.0 wt %, 17.0 wt %, 18.0 wt %, 19.0 wt %, 20.0 wt %, 21.0 wt %, 22.0 wt %, 23.0 wt %, 24.0 wt %, 25.0 wt %, 26.0 wt %, 27.0 wt %, 28.0 wt %, 29.0 wt %, 30.0 wt %, 31.0 wt %, 32.0 wt %, 33.0 wt %, 34.0 wt %, 35.0 wt %, 36.0 wt %, 37.0 wt %, 38.0 wt %, 39.0 wt %, 40.0 wt %, 41.0 wt %, 42.0 wt %, 43.0 wt %, 44.0 wt %, 45.0 wt %, 46.0 wt %, 47.0 wt %, 48.0 wt %, 49.0 wt %, or 50.0 wt %, or within a range between any two of the aforementioned values.

Alternatively, processing liquid C may be an aqueous solution of sulfuric acid or isopropyl alcohol having a concentration of 5.0 wt % to less than 100.0 wt %. For example, processing liquid C may be an aqueous solution of sulfuric acid or isopropyl alcohol having a concentration of 5.0 wt %, 10.0 wt %, 15.0 wt %, 20.0 wt %, 25.0 wt %, 30.0 wt %, 35.0 wt %, 40.0 wt %, 45.0 wt %, 50.0 wt %, 55.0 wt %, 60.0 wt %, 65.0 wt %, 70.0 wt %, 75.0 wt %, 80.0 wt %, 85.0 wt %, 90.0 wt %, 95.0 wt %, or 99.0 wt %, or within a range between any two of the aforementioned values.

In step (I-2), the exposure time to processing liquid C may be selected as needed. In one embodiment, in view of a balance between improved filtration performance and time cost, the exposure time to processing liquid C is 0.5 hours to 168.0 hours. For example, the exposure time to processing liquid C in step (I-2) may be 0.5 hours, 1.0 hour, 1.5 hours, 2.0 hours, 2.5 hours, 3.0 hours, 3.5 hours, 4.0 hours, 4.5 hours, 5.0 hours, 5.5 hours, 6.0 hours, 6.5 hours, 7.0 hours, 7.5 hours, 8.0 hours, 8.5 hours, 9.0 hours, 9.5 hours, 10.0 hours, 10.5 hours, 11.0 hours, 11.5 hours, 12.0 hours, 12.5 hours, 13.0 hours, 13.5 hours, 14.0 hours, 14.5 hours, 15.0 hours, 15.5 hours, 16.0 hours, 16.5 hours, 17.0 hours, 17.5 hours, 18.0 hours, 18.5 hours, 19.0 hours, 19.5 hours, 20.0 hours, 20.5 hours, 21.0 hours, 21.5 hours, 22.0 hours, 22.5 hours, 23.0 hours, 23.5 hours, 24.0 hours, 25.0 hours, 26.0 hours, 27.0 hours, 28.0 hours, 29.0 hours, 30.0 hours, 31.0 hours, 32.0 hours, 33.0 hours, 34.0 hours, 35.0 hours, 36.0 hours, 37.0 hours, 38.0 hours, 39.0 hours, 40.0 hours, 41.0 hours, 42.0 hours, 43.0 hours, 44.0 hours, 45.0 hours, 46.0 hours, 47.0 hours, 48.0 hours, 49.0 hours, 50.0 hours, 51.0 hours, 52.0 hours, 53.0 hours, 54.0 hours, 55.0 hours, 56.0 hours, 57.0 hours, 58.0 hours, 59.0 hours, 60.0 hours, 61.0 hours, 62.0 hours, 63.0 hours, 64.0 hours, 65.0 hours, 66.0 hours, 67.0 hours, 68.0 hours, 69.0 hours, 70.0 hours, 71.0 hours, 72.0 hours, 73.0 hours, 74.0 hours, 75.0 hours, 76.0 hours, 77.0 hours, 78.0 hours, 79.0 hours, 80.0 hours, 81.0 hours, 82.0 hours, 83.0 hours, 84.0 hours, 85.0 hours, 86.0 hours, 87.0 hours, 88.0 hours, 89.0 hours, 90.0 hours, 91.0 hours, 92.0 hours, 93.0 hours, 94.0 hours, 95.0 hours, 96.0 hours, 97.0 hours, 98.0 hours, 99.0 hours, 100.0 hours, 101.0 hours, 102.0 hours, 103.0 hours, 104.0 hours, 105.0 hours, 106.0 hours, 107.0 hours, 108.0 hours, 109.0 hours, 110.0 hours, 111.0 hours, 112.0 hours, 113.0 hours, 114.0 hours, 115.0 hours, 116.0 hours, 117.0 hours, 118.0 hours, 119.0 hours, 120.0 hours, 121.0 hours, 122.0 hours, 123.0 hours, 124.0 hours, 125.0 hours, 126.0 hours, 127.0 hours, 128.0 hours, 129.0 hours, 130.0 hours, 131.0 hours, 132.0 hours, 133.0 hours, 134.0 hours, 135.0 hours, 136.0 hours, 137.0 hours, 138.0 hours, 139.0 hours, 140.0 hours, 141.0 hours, 142.0 hours, 143.0 hours, 144.0 hours, 144.5 hours, 145.0 hours, 145.5 hours, 146.0 hours, 146.5 hours, 147.0 hours, 147.5 hours, 148.0 hours, 148.5 hours, 149.0 hours, 149.5 hours, 150.0 hours, 150.5 hours, 151.0 hours, 151.5 hours, 152.0 hours, 152.5 hours, 153.0 hours, 153.5 hours, 154.0 hours, 154.5 hours, 155.0 hours, 155.5 hours, 156.0 hours, 156.5 hours, 157.0 hours, 157.5 hours, 158.0 hours, 158.5 hours, 159.0 hours, 159.5 hours, 160.0 hours, 160.5 hours, 161.0 hours, 161.5 hours, 162.0 hours, 162.5 hours, 163.0 hours, 163.5 hours, 164.0 hours, 164.5 hours, 165.0 hours, 165.5 hours, 166.0 hours, 166.5 hours, 167.0 hours, 167.5 hours, or 168.0 hours, or within a range between any two of the aforementioned values. The “exposure time” excludes the time elapsed during the process of draining processing liquid C from the filtering material.

In step (I-2), the exposure to processing liquid C may be in a single stage or may be carried out in multiple stages. In the case of a multi-stage process, the exposure time refers to the total exposure time obtained by summing the exposure time of each stage, and excludes the time elapsed during the process of draining processing liquid C from the filtering material in each stage. For example, in the appended examples, some examples adopt a two-stage exposure process, that is, two-stages exposures with exposure times of 72 hours and 96 hours; however, the present application is not limited thereto.

### 6.2. Step (I)

The descriptions of step (I) set forth in section 1.1 of the first aspect are incorporated herein by reference, apply equally to the present aspect, and are not repeated herein for brevity.

6.3. Step (II) The descriptions of step (II) set forth in section 1.2 of the first aspect are incorporated herein by reference, apply equally to the present aspect, and are not repeated herein for brevity.

### 6.4. Filtering Material

The descriptions of the filtering material set forth in section 1.3 of the first aspect are incorporated herein by reference, apply equally to the present aspect, and are not repeated herein for brevity.

### 6.5. Optional Method Features

The filtering material processing method of the present application enhances the filtration performance of the filtering material and effectively reduces the metal content in the filtered chemical solution, thereby meeting the requirement for low metal content in chemical solutions used in semiconductor manufacturing for advanced applications. In addition, by adjusting the processing liquid concentration and/or exposure time in step (I-2), step (I), and step (II), or by repeatedly performing step (I-2), step (I), and step (II), the filtration performance improvement achieved by the filtering material processing method can be further enhanced. Therefore, in one embodiment, the filtering processing method according to the present aspect comprises performing step (I-2), step (I), and step (II), such that the filtering material satisfies the following condition: after soaking the processed filtering material in a tetramethylammonium hydroxide aqueous solution under an ambient atmosphere at 10 °C to 40 °C for 24 hours, and removing the filtering material, a total concentration of atoms, a total concentration of ions, or a total concentration of atoms and ions of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material, as determined using inductively coupled plasma mass spectrometry, is not greater than 300 ppt, preferably not greater than 200 ppt. The exemplary values of the total concentration of these elements, as well as the concentration range of tetramethylammonium hydroxide in the tetramethylammonium hydroxide aqueous solution, set forth in section 1.4 of the first aspect are incorporated herein by reference, apply equally to the present aspect, and are not repeated herein for brevity.

In addition, the filtering material processing method according to the present aspect may optionally include a step of washing the filtering material with water between the respective steps. Therefore, in one embodiment, the filtering material processing method according to the present aspect further comprises one or more steps of exposing the filtering material to water, wherein the step of exposing the filtering material to water may be performed at one or more timings before performing step (I-2), after performing step (I-2), before performing step (I), after performing step (I), before performing step (II), and after performing step (II). The descriptions of the examples of the water, the manner of exposure, and the exposure time in section 1.4 of the first aspect are incorporated herein by reference, apply equally to the present aspect, and are not repeated herein for brevity.

### 6.6. Applications

The descriptions regarding applications described in the third aspect are incorporated herein by reference, apply equally to the present aspect, and are not repeated herein for brevity.

### 7. Filtering Material According to the Seventh Aspect

The filtering material processing method according to the sixth aspect improves the filtration performance of the filtering material. Therefore, a seventh aspect of the present application is to provide a filtering material processed by the filtering material processing method according to the sixth aspect.

### 8. Chemical Solution According to the Eighth Aspect

The filtering material treated by the filtering material processing method according to the sixth aspect has improved filtration performance and is effective in reducing the metal content in the filtered chemical solution. Therefore, an eighth aspect of the present application is to provide a chemical solution which is filtered by the filtering material according to the seventh aspect.

In one embodiment, the chemical solution is a photolithography solution, more specifically a tetramethylammonium hydroxide aqueous solution, and even more specifically a tetramethylammonium hydroxide aqueous solution having a concentration of 0.4 wt % to 0.5 wt %, 2.37 wt % to 5.5 wt %, 20 wt %, 24.8 wt %, 24.99 wt %, or 25 wt %.

### 9. Examples

### 9.1. Description of Measurement Method

The present application is further illustrated by the following specific examples, wherein the measuring instruments and methods employed are as follows:

### [Metal Content Test]

The filtering material processed by the filtering material processing method shown in the example or comparative example was soaked in an aqueous solution of tetramethylammonium hydroxide having a concentration of 2.38 wt % for 24 hours, and the total concentration of ions of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material was measured under the following conditions.

Instrument: inductively coupled plasma mass spectrometer (Agilent ICPMS-8800)

Standard preparation: The sample concentration was calculated using the Standard Addition Method. The matrix of the calibration curve was prepared as an aqueous solution of tetramethylammonium hydroxide with a concentration of 2.38 wt %, and different concentrations of standards were added thereto: BK (blank sample), 50 ppt, 100 ppt, and 200 ppt.

### Rating Criteria:

Grade A: The total concentration of sodium, magnesium, aluminum, potassium, calcium, chromium, manganese, iron, cobalt, nickel, copper, zinc, silver, iridium, and lead was less than 200 ppt.
Grade B: The total concentration of sodium, magnesium, aluminum, potassium, calcium, chromium, manganese, iron, cobalt, nickel, copper, zinc, silver, iridium, and lead was 200 ppt or more and less than 300 ppt; and
Grade C: The total concentration of sodium, magnesium, aluminum, potassium, calcium, chromium, manganese, iron, cobalt, nickel, copper, zinc, silver, iridium, and lead measured was greater than 300 ppt.

### 9.2. Preparation of Filtering Material

### [Example 1]

The filter cartridge (high molecular weight polyethylene filtering material, model: ABD1UG0013EHC00106, purchased from PALL Corporation) was installed in the washing equipment. Under room temperature and atmospheric pressure conditions, the filter cartridge was soaked in an aqueous solution of isopropyl alcohol with a concentration of 5.00 wt % for 6.0 hours. Subsequently, the isopropyl alcohol aqueous solution was drained, and the filter cartridge was washed with ultrapure water for 0.5 hours.

Subsequently, under room temperature and atmospheric pressure conditions, the filter cartridge was soaked in a tetramethylammonium hydroxide aqueous solution with a concentration of 1.00 wt % for 72.0 hours. Then, the tetramethylammonium hydroxide aqueous solution was drained, and fresh tetramethylammonium hydroxide aqueous solution with a concentration of 1.00 wt % was injected again to soak the filter cartridge for 96.0 hours. In this context, the term “fresh” solution referred to a new solution that had not been used to soak the filter cartridge. Subsequently, the tetramethylammonium hydroxide aqueous solution was drained, and the filter cartridge was washed with ultrapure water for 1.0 hour.

Thereafter, under room temperature and atmospheric pressure conditions, the filter cartridge was soaked in an aqueous solution of tetramethylammonium hydroxide with a concentration of 2.38 wt % for 48.0 hours, followed by draining the aqueous solution of tetramethylammonium hydroxide, and then fresh aqueous solution of tetramethylammonium hydroxide with a concentration of 2.38 wt % was injected to soak the filter cartridge for another 48.0 hours. Subsequently, the aqueous solution of tetramethylammonium hydroxide was drained, and the filter cartridge was washed with ultrapure water to obtain the filter cartridge of Example 1.

The metal content test was conducted on the filter cartridge of Example 1 according to the measurement method described above, and the rating result was Grade A.

### [Example 2]

The filter cartridge (model: ABD1UG0013EH1, purchased from PALL Corporation) was installed in the washing equipment. Under room temperature and atmospheric pressure conditions, the filter cartridge was soaked in an aqueous solution of tetramethylammonium hydroxide at a concentration of 1.00 wt % for 72.0 hours. Then, the aqueous solution of tetramethylammonium hydroxide was drained, and fresh aqueous solution of tetramethylammonium hydroxide at a concentration of 1.00 wt % was injected to soak the filter cartridge for 96.0 hours. Subsequently, the aqueous solution of tetramethylammonium hydroxide was drained, and the filter cartridge was washed with ultrapure water for 3.0 hours.

Thereafter, under room temperature and atmospheric pressure conditions, the filter cartridge was soaked in a tetramethylammonium hydroxide aqueous solution containing a non-ionic surfactant (emulsifier; model: Surfynol 82) with a tetramethylammonium hydroxide concentration of 2.38 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained, and the filter cartridge was washed with ultrapure water to obtain the filter cartridge of Example 2.

The metal content test was conducted on the filter cartridge of Example 2 according to the measurement method described above, and the rating result was Grade A.

### [Example 3]

The filter cartridge (model: ABD1UG0013EHC00106) was installed in the washing equipment, and under room temperature and atmospheric pressure conditions, it was soaked in a hydrochloric acid aqueous solution with a concentration of 10.00 wt % for 6.0 hours, then the hydrochloric acid aqueous solution was drained, and the filter cartridge was washed with ultrapure water for 4.0 hours.

Subsequently, under room temperature and atmospheric pressure conditions, the filter cartridge was soaked in an aqueous solution of tetramethylammonium hydroxide with a concentration of 10.00 wt % for 72.0 hours, then the aqueous solution of tetramethylammonium hydroxide was drained, and fresh aqueous solution of tetramethylammonium hydroxide with a concentration of 10.00 wt % was injected again to soak the filter cartridge for 72.0 hours, then the aqueous solution of tetramethylammonium hydroxide was drained, and the filter cartridge was washed with ultrapure water for 4.0 hours.

Thereafter, under room temperature and atmospheric pressure conditions, the filter cartridge was soaked in a tetramethylammonium hydroxide aqueous solution containing a non-ionic surfactant (emulsifier; model: Surfynol 465) with a tetramethylammonium hydroxide concentration of 2.38 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained, and the filter cartridge was washed with ultrapure water to obtain the filter cartridge of Example 3.

The metal content test was conducted on the filter cartridge of Example 3 according to the measurement method described above, and the rating result was Grade A.

### [Example 4]

The filter cartridge (model: ABD1UG0013EH1) was installed in the washing equipment, and under room temperature and atmospheric pressure conditions, it was soaked in an aqueous solution of tetramethylammonium hydroxide with a concentration of 10.00 wt % for 72.0 hours. Then, the aqueous solution of tetramethylammonium hydroxide was drained, and fresh aqueous solution of tetramethylammonium hydroxide with a concentration of 10.00 wt % was injected again to soak the filter cartridge for 72.0 hours. Subsequently, the aqueous solution of tetramethylammonium hydroxide was drained, and the filter cartridge was washed with ultrapure water for 5.0 hours.

Thereafter, under room temperature and atmospheric pressure conditions, the filter cartridge was soaked in a tetramethylammonium hydroxide aqueous solution containing a non-ionic surfactant (emulsifier; model: Surfynol 485) with a tetramethylammonium hydroxide concentration of 2.38 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained, and the filter cartridge was washed with ultrapure water to obtain the filter cartridge of Example 4.

The metal content test was conducted on the filter cartridge of Example 4 according to the measurement method described above, and the rating result was Grade A.

### [Example 5]

The filter cartridge (model: ABD1UG0013EH1) was installed in the washing equipment, and under room temperature and atmospheric pressure conditions, it was soaked in a hydrogen peroxide aqueous solution with a concentration of 10.00 wt % for 0.5 hours, then the hydrogen peroxide aqueous solution was drained, and the filter cartridge was washed with ultrapure water for 6.0 hours.

Subsequently, under room temperature and atmospheric pressure conditions, the filter cartridge was soaked in a tetramethylammonium hydroxide aqueous solution containing a non-ionic surfactant (emulsifier; model: DYNOL 604) with a tetramethylammonium hydroxide concentration of 10.00 wt % for 72.0 hours. Then, the tetramethylammonium hydroxide aqueous solution was drained, and fresh tetramethylammonium hydroxide aqueous solution of the same concentration and composition was injected to soak the filter cartridge for another 72.0 hours. Afterward, the tetramethylammonium hydroxide aqueous solution was drained, and the filter cartridge was washed with ultrapure water for 7.0 hours.

Thereafter, under room temperature and atmospheric pressure conditions, the filter cartridge was soaked in an aqueous solution of tetramethylammonium hydroxide having a concentration of 2.38 wt % for 48.0 hours, then the aqueous solution of tetramethylammonium hydroxide was drained, and fresh aqueous solution of tetramethylammonium hydroxide having a concentration of 2.38 wt % was injected again to soak the filter cartridge for 48.0 hours, then the aqueous solution of tetramethylammonium hydroxide was drained, and the filter cartridge was washed with ultrapure water to obtain the filter cartridge of Example 5.

The metal content test was conducted on the filter cartridge of Example 5 according to the measurement method described above, and the rating result was Grade A.

### [Example 6]

The filter cartridge (model: ABD1UG0013EHC00106) was installed in the washing equipment, and under room temperature and atmospheric pressure conditions, it was soaked in a hydrogen peroxide aqueous solution with a concentration of 0.50 wt % for 0.5 hours, then the hydrogen peroxide aqueous solution was drained, and the filter cartridge was washed with ultrapure water for 9.0 hours.

Subsequently, under room temperature and atmospheric pressure conditions, the filter cartridge was soaked in an aqueous solution of tetramethylammonium hydroxide at a concentration of 0.50 wt % for 0.5 hours, then the aqueous solution of tetramethylammonium hydroxide was drained, and the filter cartridge was washed with ultrapure water for 9.0 hours.

Thereafter, under room temperature and atmospheric pressure conditions, the filter cartridge was soaked in a tetramethylammonium hydroxide aqueous solution containing a non-ionic surfactant (emulsifier; model: DYNOL 607) with a tetramethylammonium hydroxide concentration of 2.38 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained, and the filter cartridge was washed with ultrapure water to obtain the filter cartridge of Example 6.

The metal content test was conducted on the filter cartridge of Example 6 according to the measurement method described above, and the rating result was Grade A.

### [Example 7]

The filter cartridge (model: ABD1UG0013EHC00106) was installed in the washing equipment, and under room temperature and atmospheric pressure conditions, it was soaked in an isopropyl alcohol aqueous solution with a concentration of 50.00 wt % for 3.0 hours, then the isopropyl alcohol aqueous solution was drained, and the filter cartridge was washed with ultrapure water for 10.0 hours.

Subsequently, under room temperature and atmospheric pressure conditions, the filter cartridge was soaked in a tetramethylammonium hydroxide aqueous solution containing a non-ionic surfactant (emulsifier; model: DYNOL 607) with a tetramethylammonium hydroxide concentration of 5.00 wt % for 72.0 hours, then the tetramethylammonium hydroxide aqueous solution was drained, and the filter cartridge was washed with ultrapure water for 19.0 hours.

Thereafter, under room temperature and atmospheric pressure conditions, the filter cartridge was soaked in a tetramethylammonium hydroxide aqueous solution containing a non-ionic surfactant (emulsifier; model: Olfine E1010) with a tetramethylammonium hydroxide concentration of 1.00 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained again, and fresh tetramethylammonium hydroxide aqueous solution of the same concentration was injected to soak the filter cartridge for another 48.0 hours. After draining the tetramethylammonium hydroxide aqueous solution again, fresh tetramethylammonium hydroxide aqueous solution of the same concentration and composition was injected to soak the filter cartridge for 24.0 hours. Finally, the tetramethylammonium hydroxide aqueous solution was drained, and the filter cartridge was washed with ultrapure water to obtain the filter cartridge of Example 7.

The metal content test was conducted on the filter cartridge of Example 7 according to the measurement method described above, and the rating result was Grade A.

### [Example 8]

The filter cartridge (model: ABD1UG0013EH1) was installed in the washing equipment. Under room temperature and atmospheric pressure conditions, the filter cartridge was soaked in a tetramethylammonium hydroxide aqueous solution containing a non-ionic surfactant (emulsifier; model: DYNOL 604) with a tetramethylammonium hydroxide concentration of 5.00 wt % for 72.0 hours. Then, the tetramethylammonium hydroxide aqueous solution was drained, and the filter cartridge was washed with ultrapure water for 18.0 hours.

Thereafter, under room temperature and atmospheric pressure conditions, the filter cartridge was soaked in a tetramethylammonium hydroxide aqueous solution containing a non-ionic surfactant (emulsifier; model: DYNOL 607) with a tetramethylammonium hydroxide concentration of 1.00 wt % for 48.0 hours. Then, the tetramethylammonium hydroxide aqueous solution was drained, and fresh tetramethylammonium hydroxide aqueous solution of the same concentration and composition was injected to soak the filter cartridge for another 48.0 hours. Subsequently, the tetramethylammonium hydroxide aqueous solution was drained again, and fresh tetramethylammonium hydroxide aqueous solution of the same concentration and composition was injected to soak the filter cartridge for another 48.0 hours. After draining the tetramethylammonium hydroxide aqueous solution again, fresh tetramethylammonium hydroxide aqueous solution of the same concentration and composition was injected to soak the filter cartridge for 24.0 hours. Finally, the tetramethylammonium hydroxide aqueous solution was drained, and the filter cartridge was washed with ultrapure water to obtain the filter cartridge of Example 8.

The metal content test was conducted on the filter cartridge of Example 8 according to the measurement method described above, and the rating result was Grade A.

### [Example 9]

The filter cartridge (model: ABD1UG0013EH1) was installed in the washing equipment, and under room temperature and atmospheric pressure conditions, it was soaked in a hydrochloric acid aqueous solution with a concentration of 1.00 wt % for 10.0 hours, then the hydrochloric acid aqueous solution was drained, and the filter cartridge was washed with ultrapure water for 24.0 hours.

Subsequently, under room temperature and atmospheric pressure conditions, the filter cartridge was soaked in a tetramethylammonium hydroxide aqueous solution containing a non-ionic surfactant (emulsifier; model: Olfine E1010) with a tetramethylammonium hydroxide concentration of 5.00 wt % for 72.0 hours, then the tetramethylammonium hydroxide aqueous solution was drained, and the filter cartridge was washed with ultrapure water for 3.0 hours.

Thereafter, under room temperature and atmospheric pressure conditions, the filter cartridge was soaked in a 2.00 wt % tetramethylammonium hydroxide aqueous solution for 48.0 hours, then the tetramethylammonium hydroxide aqueous solution was drained, fresh tetramethylammonium hydroxide aqueous solution of the same concentration was injected again to soak the filter cartridge for 48.0 hours, then the tetramethylammonium hydroxide aqueous solution was drained again, fresh tetramethylammonium hydroxide aqueous solution of the same concentration was injected again to soak the filter cartridge for 48.0 hours, then the tetramethylammonium hydroxide aqueous solution was drained again, and the filter cartridge was washed with ultrapure water to obtain the filter cartridge of Example 9.

The metal content test was conducted on the filter cartridge of Example 9 according to the measurement method described above, and the rating result was Grade A.

### [Example 10]

The filter cartridge (model: ABD1UG0013EHC00106) was installed in the washing equipment, and was soaked in an aqueous solution of isopropyl alcohol with a concentration of 10.00 wt % for 12.0 hours under room temperature and atmospheric pressure conditions. Then, the aqueous solution of isopropyl alcohol was drained, and the filter cartridge was washed with ultrapure water for 4.0 hours.

Subsequently, under room temperature and atmospheric pressure conditions, the filter cartridge was soaked in an aqueous solution of tetramethylammonium hydroxide with a concentration of 15.00 wt % for 48.0 hours, then the aqueous solution of tetramethylammonium hydroxide was drained, and the filter cartridge was washed with ultrapure water for 18.0 hours.

Thereafter, under room temperature and atmospheric pressure conditions, the filter cartridge was soaked in a tetramethylammonium hydroxide aqueous solution containing a non-ionic surfactant (emulsifier; model: DYNOL 604) with a tetramethylammonium hydroxide concentration of 2.50 wt % for 48.0 hours. Then, the tetramethylammonium hydroxide aqueous solution was drained, and fresh tetramethylammonium hydroxide aqueous solution of the same concentration and composition was injected to soak the filter cartridge for 24.0 hours. Subsequently, the tetramethylammonium hydroxide aqueous solution was drained, and the filter cartridge was washed with ultrapure water to obtain the filter cartridge of Example 10.

The metal content test was conducted on the filter cartridge of Example 10 according to the measurement method described above, and the rating result was Grade A.

### [Example 11]

The filter cartridge (model: ABD1UG0013EH1) was installed in the washing equipment, and was soaked in a hydrochloric acid aqueous solution with a concentration of 0.50 wt % for 24.0 hours under room temperature and atmospheric pressure conditions, then the hydrochloric acid aqueous solution was drained, and the filter cartridge was washed with ultrapure water for 23.0 hours.

Subsequently, under room temperature and atmospheric pressure conditions, the filter cartridge was soaked in a tetramethylammonium hydroxide aqueous solution containing a non-ionic surfactant (emulsifier; model: DYNOL 604) with a tetramethylammonium hydroxide concentration of 24.80 wt % for 24.0 hours, then the tetramethylammonium hydroxide aqueous solution was drained, and the filter cartridge was washed with ultrapure water for 9.0 hours.

Thereafter, under room temperature and atmospheric pressure conditions, the filter cartridge was soaked in a 3.00 wt % tetramethylammonium hydroxide aqueous solution for 48.0 hours, then the tetramethylammonium hydroxide aqueous solution was drained, and the filter cartridge was washed with ultrapure water to obtain the filter cartridge of Example 11.

The metal content test was conducted on the filter cartridge of Example 11 according to the measurement method described above, and the rating result was Grade B.

### [Example 12]

The filter cartridge (model: ABD1UG0013EH1) was installed in the washing equipment, and was soaked in an aqueous solution of isopropyl alcohol with a concentration of 5.00 wt % for 72.0 hours under room temperature and atmospheric pressure conditions, then the isopropyl alcohol aqueous solution was drained, and the filter cartridge was washed with ultrapure water for 15.0 hours.

Subsequently, under room temperature and atmospheric pressure conditions, the filter cartridge was soaked in a tetramethylammonium hydroxide aqueous solution containing a non-ionic surfactant (emulsifier; model: DYNOL 607) with a tetramethylammonium hydroxide concentration of 24.99 wt % for 12.0 hours, then the tetramethylammonium hydroxide aqueous solution was drained, and the filter cartridge was washed with ultrapure water for 22.0 hours.

Thereafter, under room temperature and atmospheric pressure conditions, the filter cartridge was soaked in an aqueous solution of tetramethylammonium hydroxide with a concentration of 4.00 wt % for 24.0 hours, then the aqueous solution of tetramethylammonium hydroxide was drained, and the filter cartridge was washed with ultrapure water to obtain the filter cartridge of Example 12.

The metal content test was conducted on the filter cartridge of Example 12 according to the measurement method described above, and the rating result was Grade B.

### [Example 13]

The filter cartridge (model: ABD1UG0013EHC00106) was installed in the washing equipment. Under room temperature and atmospheric pressure conditions, the filter cartridge was soaked in a tetramethylammonium hydroxide aqueous solution containing a non-ionic surfactant (emulsifier; model: Surfynol 82) with a tetramethylammonium hydroxide concentration of 24.99 wt % for 12.0 hours. Then, the tetramethylammonium hydroxide aqueous solution was drained, and the filter cartridge was washed with ultrapure water for 1.0 hour.

Thereafter, under room temperature and atmospheric pressure conditions, the filter cartridge was soaked in a 4.00 wt % tetramethylammonium hydroxide aqueous solution for 24.0 hours, then the tetramethylammonium hydroxide aqueous solution was drained, and the filter cartridge was washed with ultrapure water to obtain the filter cartridge of Example 13.

The metal content test was conducted on the filter cartridge of Example 13 according to the measurement method described above, and the rating result was Grade B.

### [Example 14]

The filter cartridge (model: ABD1UG0013EH1) was installed in the washing equipment. Under room temperature and atmospheric pressure conditions, the filter cartridge was soaked in a hydrochloric acid aqueous solution with a concentration of 0.50 wt % for 72.0 hours. Then, the hydrochloric acid aqueous solution was drained, and fresh hydrochloric acid aqueous solution with a concentration of 0.50 wt % was injected to soak the filter cartridge for 96.0 hours. Subsequently, the hydrochloric acid aqueous solution was drained again, and the filter cartridge was washed with ultrapure water for 6.0 hours.

Subsequently, under room temperature and atmospheric pressure conditions, the filter cartridge was soaked in an aqueous solution of tetramethylammonium hydroxide having a concentration of 25.00 wt % for 1.0 hour, then the aqueous solution of tetramethylammonium hydroxide was drained, and the filter cartridge was washed with ultrapure water for 11.0 hours.

Thereafter, under room temperature and atmospheric pressure conditions, the filter cartridge was soaked in a 5.00 wt % tetramethylammonium hydroxide aqueous solution for 12.0 hours, then the tetramethylammonium hydroxide aqueous solution was drained, and the filter cartridge was washed with ultrapure water to obtain the filter cartridge of Example 14.

The metal content test was conducted on the filter cartridge of Example 14 according to the measurement method described above, and the rating result was Grade B.

### [Example 15]

The filter cartridge (model: ABD1UG0013EHC00106) was installed in the washing equipment. Under room temperature and atmospheric pressure conditions, the filter cartridge was soaked in an aqueous solution of isopropyl alcohol with a concentration of 90.00 wt % for 0.5 hours. Then, the isopropyl alcohol aqueous solution was drained, and the filter cartridge was washed with ultrapure water for 17.0 hours.

Subsequently, under room temperature and atmospheric pressure conditions, the filter cartridge was soaked in an aqueous solution of tetramethylammonium hydroxide with a concentration of 25.00 wt % for 0.5 hours, then the aqueous solution of tetramethylammonium hydroxide was drained, and the filter cartridge was washed with ultrapure water for 22.0 hours.

Thereafter, the filter cartridge was soaked in an aqueous solution of tetramethylammonium hydroxide having a concentration of 2.80 wt % at room temperature and atmospheric pressure for 48.0 hours, then the aqueous solution of tetramethylammonium hydroxide was drained, and the filter cartridge was washed with ultrapure water to obtain the filter cartridge of Example 15.

The metal content test was conducted on the filter cartridge of Example 15 according to the measurement method described above, and the rating result was Grade B.

### [Example 16]

The filter cartridge (model: ABD1UG0013EH1) was installed in the washing equipment, and under room temperature and atmospheric pressure conditions, it was soaked in a tetramethylammonium hydroxide aqueous solution containing a non-ionic surfactant (emulsifier; model: DYNOL 607) with a tetramethylammonium hydroxide concentration of 25.00 wt % for 0.5 hours, then the tetramethylammonium hydroxide aqueous solution was drained, and the filter cartridge was washed with ultrapure water for 16.0 hours.

Thereafter, under room temperature and atmospheric pressure conditions, the filter cartridge was soaked in a tetramethylammonium hydroxide aqueous solution containing a non-ionic surfactant (emulsifier; model: DYNOL 604) with a tetramethylammonium hydroxide concentration of 2.80 wt % for 48.0 hours, then the tetramethylammonium hydroxide aqueous solution was drained, and the filter cartridge was washed with ultrapure water to obtain the filter cartridge of Example 16.

The metal content test was conducted on the filter cartridge of Example 16 according to the measurement method described above, and the rating result was Grade B.

### [Example 17]

The filter cartridge (model: ABD1UG0013EHC00106) was installed in the washing equipment, and under room temperature and atmospheric pressure conditions, it was soaked in an isopropyl alcohol aqueous solution with a concentration of 80.00 wt % for 0.5 hours. Then, the isopropyl alcohol aqueous solution was drained, and the filter cartridge was washed with ultrapure water for 2.0 hours.

Subsequently, under room temperature and atmospheric pressure conditions, the filter cartridge was soaked in a tetramethylammonium hydroxide aqueous solution containing a non-ionic surfactant (emulsifier; model: Olfine E1010) with a tetramethylammonium hydroxide concentration of 25.00 wt % for 0.5 hours, then the tetramethylammonium hydroxide aqueous solution was drained, and the filter cartridge was washed with ultrapure water for 8.0 hours.

Thereafter, under room temperature and atmospheric pressure conditions, the filter cartridge was soaked in a tetramethylammonium hydroxide aqueous solution containing a non-ionic surfactant (emulsifier; model: Surfynol 82) with a tetramethylammonium hydroxide concentration of 2.10 wt % for 48.0 hours. Then, the tetramethylammonium hydroxide aqueous solution was drained, and fresh tetramethylammonium hydroxide aqueous solution of the same concentration and composition was injected to soak the filter cartridge for 24.0 hours. Subsequently, the tetramethylammonium hydroxide aqueous solution was drained again, and the filter cartridge was washed with ultrapure water to obtain the filter cartridge of Example 17.

The metal content test was conducted on the filter cartridge of Example 17 according to the measurement method described above, and the rating result was Grade B.

### [Comparative Example 1]

The filter cartridge (model: ABD1UG0013EH1) was installed in the washing equipment, and under room temperature and atmospheric pressure conditions, it was soaked in an aqueous solution of isopropyl alcohol with a concentration of 0.10 wt % for 15 minutes, then the isopropyl alcohol aqueous solution was drained, and the filter cartridge was washed with ultrapure water to obtain the filter cartridge of Comparative Example 1.

The metal content test was conducted on the filter cartridge of Comparative Example 1 according to the measurement method described above, and the rating result was Grade C.

### [Comparative Example 2]

The filter cartridge (model: ABD1UG0013EHC00106) was installed in the washing equipment, and under room temperature and atmospheric pressure conditions, it was soaked in ultrapure water for 15 minutes, then the water was drained, and the filter cartridge was cleaned with ultrapure water to obtain the filter cartridge of Comparative Example 2.

The metal content test was conducted on the filter cartridge of Comparative Example 2 according to the measurement method described above, and the rating result was Grade C.

### [Comparative Example 3]

The filter cartridge (model: ABD1UG0013EH1) was installed in the washing equipment, and under room temperature and atmospheric pressure conditions, it was soaked in an aqueous solution of tetramethylammonium hydroxide with a concentration of 0.10 wt % for 15 minutes. Then, the aqueous solution of tetramethylammonium hydroxide was drained, and the filter cartridge was washed with ultrapure water to obtain the filter cartridge of Comparative Example 3.

The metal content test was conducted on the filter cartridge of Comparative Example 3 according to the measurement method described above, and the rating result was Grade C.

### [Comparative Example 4]

The filter cartridge (model: ABD1UG0013EH1) was installed in the washing equipment, and under room temperature and atmospheric pressure conditions, it was soaked in an aqueous hydrochloric acid solution with a concentration of 0.10 wt % for 15 minutes, then the hydrochloric acid solution was drained, and the filter cartridge was washed with ultrapure water to obtain the filter cartridge of Comparative Example 4.

The metal content test was conducted on the filter cartridge of Comparative Example 4 according to the measurement method described above, and the rating result was Grade C.

### 9.3. Filtering Material Testing and Evaluation

Examples 1 to 17 show that the filtering material produced by the filtering material processing method of the present application have improved filtration performance and provide chemical solutions with low metal content. Therefore, the filtering material are particularly suitable for filtration tasks of chemical solutions used in semiconductor manufacturing that require extremely low metal content. In contrast, Comparative Examples 1 to 4 show that if the filter cartridge does not undergo the filtering material processing method of the present application comprising step (I) and step (II), even if it undergoes treatment with isopropyl alcohol aqueous solution, ultrapure water, tetramethylammonium hydroxide aqueous solution, or hydrochloric acid aqueous solution, it still cannot achieve improved filtration performance, and the metal content rating results are poor.

The aforementioned examples are used to illustrated the principles and effects of the present application and described the technical features of the present application, but are not used to limit the scope of protection of the present application. People skilled in this field may proceed with a variety of modifications and replacements based on the disclosures and suggestions of the invention as described. Therefore, the scope of protection of the present application is that as defined in the appended claims.

What is claimed is:

1. A method of processing a filtering material, comprising:
step (I): exposing the filtering material to a processing liquid A; and
step (II): exposing the filtering material to a processing liquid B,
wherein the processing liquid A is a tetramethylammonium hydroxide aqueous solution having a concentration of 0.4 wt % to 27.0 wt %, and the processing liquid B is a tetramethylammonium hydroxide aqueous solution having a concentration of 0.4 wt % to 5.5 wt %, and wherein step (II) is performed after step (I), or step (I) is performed after step (II).

2. The method of claim 1, wherein an exposure time in step (I) is 0.5 hours to 168.0 hours, and an exposure time in step (II) is 12.0 hours to 168.0 hours.

3. The method of claim 1, wherein the exposure manner in step (I) and step (II) is independently selected from soaking, rinsing, flushing, or a combination thereof.

4. The method of claim 1, wherein the processing liquid A has a tetramethylammonium hydroxide concentration different from that of the processing liquid B.

5. The method of claim 1, wherein at least one of processing liquid A and processing liquid B comprises an additive selected from the group consisting of a surfactant, a defoamer, a pH stabilizer, a chelating agent, and combinations thereof.

6. The method of claim 2, wherein at least one of processing liquid A and processing liquid B comprises an additive selected from the group consisting of a surfactant, a defoamer, a pH stabilizer, a chelating agent, and combinations thereof.

7. The method of claim 3, wherein at least one of processing liquid A and processing liquid B comprises an additive selected from the group consisting of a surfactant, a defoamer, a pH stabilizer, a chelating agent, and combinations thereof.

8. The method of claim 1, wherein a filter medium of the filtering material is selected from the group consisting of polyethylene, polypropylene, polytetrafluoroethylene, polysulfone, polyamide, and combinations thereof.

9. The method of claim 2, wherein a filter medium of the filtering material is selected from the group consisting of polyethylene, polypropylene, polytetrafluoroethylene, polysulfone, polyamide, and combinations thereof.

10. The method of claim 3, wherein a filter medium of the filtering material is selected from the group consisting of polyethylene, polypropylene, polytetrafluoroethylene, polysulfone, polyamide, and combinations thereof.

11. The method of claim 1, wherein the filtering material processed by the method exhibits the following characteristics: after soaking the processed filtering material in a tetramethylammonium hydroxide aqueous solution under an ambient atmosphere at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material is not greater than 300 ppt, as determined using inductively coupled plasma mass spectrometry.

12. The method of claim 2, wherein the filtering material processed by the method exhibits the following characteristics: after soaking the processed filtering material in a tetramethylammonium hydroxide aqueous solution under an ambient atmosphere at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material is not greater than 300 ppt, as determined using inductively coupled plasma mass spectrometry.

13. The method of claim 3, wherein the filtering material processed by the method exhibits the following characteristics: after soaking the processed filtering material in a tetramethylammonium hydroxide aqueous solution under an ambient atmosphere at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium, and lead in the tetramethylammonium hydroxide aqueous solution after soaking the processed filtering material is not greater than 300 ppt, as determined using inductively coupled plasma mass spectrometry.

14. A filtering material, which has the following characteristics: after soaking the filtering material in a tetramethylammonium hydroxide aqueous solution under an ambient atmosphere at 10 °C to 40 °C for 24 hours, and removing the filtering material therefrom, a total concentration of sodium, magnesium, aluminum, potassium, calcium, chromium, manganese, iron, cobalt, nickel, copper, zinc, silver, iridium, and lead in the tetramethylammonium hydroxide aqueous solution after soaking the filtering material is not greater than 300 ppt, as determined using inductively coupled plasma mass spectrometry.

15. A filtering material, which is processed by the method of claim 1.

16. A photolithography solution, which has the following characteristics: a total concentration of sodium, magnesium, aluminum, potassium, calcium, chromium, manganese, iron, cobalt, nickel, copper, zinc, silver, iridium, and lead in the photolithography solution, determined using inductively coupled plasma mass spectrometry, is not greater than 300 ppt.

17. The photolithography solution of claim 16, which is a tetramethylammonium hydroxide aqueous solution.

18. A photolithography solution, which is filtered through the filtering material of claim 14.

19. A photolithography solution, which is filtered through the filtering material of claim 15.
